(19) United States
(12) Patent Application Publication
(10) Pub. No.: US 2012/0329350 A1
(43) Pub. Date: Dec. 27, 2012

(54) HOT MELT ADHESIVE COMPOSITIONS THAT INCLUDE A MODIFIED PROPYLENE-ALPHA-OLEFIN POLYMER AND EXHIBIT LOW BLEED THROUGH

(75) Inventors: Kevin Davis, North St. Paul, MN (US); Sharf U. Ahmed, Woodbury, MN (US); Stephen M. Willging, Minneapolis, MN (US); Michael J. Nowak, Limo Lakes, MN (US)

(73) Assignee: H.B. Fuller Company, St. Paul, MN (US)

(21) Appl. No.: 13/529,299

(22) Filed: Jun. 21, 2012

Related U.S. Application Data
(60) Provisional application No. 61/501,592, filed on Jun. 27, 2011.

(51) Int. Cl. C09J 123/20; B32B 5/02

(52) U.S. Cl. 442/327; 524/579

(57) ABSTRACT

A hot melt adhesive composition that includes a propylene-alpha-olefin polymer including at least 50 mole % propylene and has a ratio of z average molecular weight (Mz) to number average molecular weight (Mn) (Mz/Mn) from greater than 20 and no greater than 50, a ratio of Mz to weight average molecular weight (Mw) (Mz/Mw) from greater than 2.5 to no greater than 6, a crystallinity of at least 5%, and a viscosity of no greater than 2,500 centipoise at 190° C., and from 10% by weight to no greater than 30% by weight tackifying resin, the adhesive composition having a viscosity no greater than 10,000 centipoise at 149° C.

### CROSS-REFERENCE TO RELATED APPLICATIONS

This application claims the benefit of U.S. Provisional Application No. 61/501,592, filed Jun. 27, 2011, and incorporated herein.

### BACKGROUND

The invention relates to reducing adhesive bleed through.

Hot melt adhesives are often used to bond nonwoven layers to various substrates including polymer films. In many of these constructions it is important that the hot melt adhesive bond the nonwoven layer to the polymer film but not bleed through the nonwoven layer. Bleed through occurs when the adhesive composition (or a component of the adhesive composition) becomes present on a surface of an article that is opposite the adhesive coated surface of the article. Bleed through is undesirable and can impair performance of the adhesive, as well as the utility of the article made therefrom.

Bleed through can occur at the time the adhesive is coated and when pressure is applied to the adhesive coated article. Pressure may cause the hot melt adhesive to flow through, i.e., bleed through, a porous substrate such as a nonwoven layer. The presence of bleed through can cause articles to stick to one another or to another substrate or article. When articles unintentionally stick to one another as a result of bleed through, it is referred to as blocking.

Nonwoven substrates are porous. It is often difficult to form a good adhesive bond to a nonwoven substrate while simultaneously achieving an article that is free from blocking and bleed through.

### SUMMARY

In one aspect, the invention features a hot melt adhesive composition that includes a propylene-alpha-olefin polymer comprising at least 50 mole % propylene and having a ratio of z average molecular weight (Mz) to number average molecular weight (Mn) (Mz/Mn) from greater than 20 to no greater than 50, a ratio of Mz to weight average molecular weight (Mw) (Mz/Mw) from greater than 2.5 to no greater than 6, a crystallinity of at least 5%, and a viscosity of no greater than 2500 centipoise at 190° C., and from 10% by weight to no greater than 30% by weight tackifying resin, the adhesive composition having a viscosity no greater than 10,000 centipoise at 149° C. In one embodiment, the hot melt adhesive composition is pressure-sensitive.

In another aspect, the invention features a pressure-sensitive hot melt adhesive composition that includes a first polymer that includes the reaction product of a propylene-alpha-olefin polymer comprising that includes at least 50 mole % propylene and having a Mz/Mn of greater than 45, a Mz/Mw of greater than 3.2, a viscosity no greater than 10,000 centipoise at 190° C., and a crystallinity of at least 5%, and a free radical initiator, and from 10% by weight to no greater than about 30% by weight tackifying resin, the adhesive composition having a viscosity no greater than 10,000 centipoise at 149° C. In one embodiment, a hot melt adhesive composition disclosed herein has a viscosity no greater than about 8,000 centipoise at 149° C.

In another embodiment, a hot melt adhesive composition disclosed herein exhibits an initial peel force of at least 100 grams. In some embodiments, a hot melt adhesive composition disclosed herein exhibits an initial peel force of at least about 200 grams. In one embodiment, a hot melt adhesive composition disclosed herein exhibits an initial low coat weight peel force of at least about 150 grams. In other embodiments, a hot melt adhesive composition disclosed herein exhibits a bleed through of less than about 30 grams.

In one embodiment, the hot melt adhesive composition exhibits a bleed through of less than about 30 grams and an initial low coat weight peel force of at least 100 grams. In other embodiments, the hot melt adhesive composition exhibits an initial low coat weight peel force of at least about 150 grams. In one embodiment, the hot melt adhesive composition exhibits a bleed through of less than about 30 grams and an initial peel force of at least about 175 grams. In other embodiments, the hot melt adhesive composition exhibits no bleed through.

In some embodiments, the propylene-alpha-olefin polymer exhibits at least 10% crystallinity. In other embodiments, the propylene-alpha-olefin polymer exhibits a heat of fusion of no greater than about 30 J/g.

In some embodiments, the hot melt adhesive composition includes no greater than about 25% by weight tackifying agent. In one embodiment, the hot melt adhesive composition includes at least about 50% by weight propylene-alpha-olefin polymer. In other embodiments, the hot melt adhesive composition includes at least about 70% by weight propylene-alpha-olefin polymer. In some embodiments, the hot melt adhesive composition further includes from about 0.5% by weight to about 3% by weight wax. In another embodiment, the hot melt adhesive composition further includes at least one of plasticizer and wax. In other embodiments, the hot melt adhesive composition further includes a plasticizer that includes oil.

In another aspect, the invention features a hot melt adhesive composition that includes a propylene-alpha-olefin polymer that includes at least 50 mole % propylene, and from 10% by weight to no greater than about 30% by weight tackifying resin, the adhesive composition having a viscosity no greater than 10,000 centipoise at 149° C., exhibiting an initial low coat weight peel force of at least 175 g, and exhibiting a bleed through of no greater than 30 grams. In some embodiments, the hot melt adhesive composition is a pressure-sensitive composition.

In other aspects, the invention features an article that includes a first substrate, a hot melt adhesive composition disclosed herein, and a nonwoven web adhered to the first substrate through the hot melt adhesive composition. In one embodiment, the hot melt adhesive composition of the article exhibits a bleed through of no greater than about 30 grams. In another embodiment, the nonwoven web includes a first major surface and a second major surface opposite the first major surface, the hot melt adhesive is disposed on the first major surface of the nonwoven web, and the second major surface of the nonwoven web is non-tacky. In some embodiments, the article is nonblocking.

The invention features a hot melt adhesive composition that forms good adhesive bonds to nonwoven substrates and exhibits little to no bleed through on nonwoven substrates.

The invention also features a hot melt adhesive composition that has a relatively high z average molecular weight, a relatively low viscosity, and exhibits good sprayability.

Other features and advantages will be apparent from the following description of the preferred embodiments and from the claims.

### GLOSSARY

In reference to the invention, these terms have the meanings set forth below:

The term “modified propylene-alpha-olefin polymer” means a propylene-alpha-olefin polymer that is the reaction product of a propylene-alpha-olefin polymer and a free radical initiator.

The term “wax” means a polymer having a weight average molecular weight (Mw) of less than 20,000 g/mole and crystallinity.

### DETAILED DESCRIPTION

The hot melt adhesive composition includes at least one propylene-alpha-olefin polymer that includes at least 50 mole % propylene and has a ratio of z average molecular weight (Mz) to number average molecular weight (Mn) (Mz/Mn) of greater than 20, a ratio of Mz to weight average molecular weight (Mw) (Mz/Mw) from greater than 2.5 to no greater than 6, and a viscosity of no greater than 2500 centipoise at 190° C., and from 10% by weight to 30% by weight tackifying agent. The hot melt adhesive composition can be a pressure-sensitive hot melt adhesive composition (i.e., tacky at room temperature) or non-tacky at room temperature.

The adhesive composition exhibits a peel force of at least 50 grams (g), at least about 100 g, at least about 150 g, at least about 200 g, or even at least about 300 g at a coat weight of 6.2 g/m², a peel force of at least 50 g, at least 75 g, at least 100 g, or even at least 150 g at a coat weight of 4.7 g/m², or even a peel force of at least 75 g, at least about 100 g, at least about 150 g, or even at least about 200 g at a coat weight of 4.0 g/m², initially, after aging for at least two weeks at 120° F. (49° C.) and 50% relative humidity, or even after aging for at least four weeks at 120° F. (49° C.) and 50% relative humidity.

The hot melt adhesive composition preferably exhibits a bleed through of no greater than about 30 g, no greater than about 20 g, no greater than about 10 g, no greater than about 5 g, or even 0 g when tested according to the Bleed Through test method. The adhesive composition also preferably does not flow through a nonwoven web when used to adhere the nonwoven web to another substrate.

The adhesive composition is sprayable. Useful measures of sprayability include, e.g., viscosity and Mz. The adhesive composition preferably exhibits a viscosity of no greater than 17,000 centipoise (cps), no greater than about 15,500 cps, or even no greater than about 15,000 cps at 135° C., or even no greater than about 10,000 cps, no greater than about 8,000 cps, no greater than about 7,000 cps, no greater than about 6,500 cps, or even from about 2,500 cps to about 10,000 cps at 149° C.

The adhesive composition also preferably has a z average molecular weight (Mz) of no greater than 200,000 g/mole, no greater than about 175,000 g/mole, no greater than about 145,000 g/mole, or even no greater than about 120,000 g/mole.

Propylene-Alpha-Olefin Polymer

The propylene-alpha-olefin polymer exhibits a viscosity of no greater than 2,500 cps, no greater than about 2,000 cps, or even no greater than about 1500 cps, at 190° C., a Mz/Mn of greater than 20, greater than 25, greater than 30, or even from greater than 20 to no greater than 50, and a Mz/Mw of at least 2.5, at least 2.8, at least 3.0, no greater than 6, no greater than 5.5, no greater than 5, or even no greater than 4.5. The propylene-alpha-olefin polymer also preferably exhibits a glass transition temperature (Tg) of less than 0° C., less than −10° C., or even less than −20° C. The propylene-alpha-olefin polymer can be nontacky or tacky at room temperature.

Useful propylene-alpha-olefin polymers exhibit a number average molecular weight (Mn) of at least about 1000 g/mole, no greater than about 10,000 g/mole, or even no greater than about 8,000 g/mole, a weight average molecular weight no greater than about 50,000 g/mole, no greater than about 40,000 g/mole, at least about 15,000 g/mole, or even at least about 10,000 g/mole, and a z average molecular weight (Mz) of no greater than 200,000 g/mole, no greater than about 175,000 g/mole, no greater than about 145,000 g/mole, no greater than about 120,000 g/mole, or even no greater than about 100,000 g/mole.

Useful propylene-alpha-olefin polymers also exhibit a crystallinity of at least 5%, at least about 10%, no greater than about 30%, or even no greater than about 20%, and a heat of fusion of no greater than about 60 J/g, no greater than about 30 J/g, or even no greater than about 20 J/g.

Useful propylene-alpha-olefin polymers include homopolymers, copolymers (e.g., copolymers, terpolymers, and higher order polymers), and combinations thereof (e.g., blends of at least two different homopolymers, blends of at least two different copolymers, and blends of homopolymers and copolymers). Useful propylene-alpha-olefin copolymers are derived from propylene and at least one alpha-olefin comonomer having at least two carbon atoms, or even at least four carbon atoms, including, e.g., ethylene, butene, pentene, hexene, heptene, octene, nonene, decene, dodecene, 4-methyl-pentene-1,3-methyl pentene-1,3,5,5-trimethyl-hexene-1,5-ethyl-1-nonene, and combinations thereof. Useful alpha-olefin comonomers include mono-alpha olefins (i.e., one unsaturated double bond), and higher order olefins (e.g., a di-olefin, e.g., 1,9-decadiene). Useful propylene-alpha-olefin copolymers are derived from at least about 50% by weight, at least about 60 mole %, no greater than about 80 mole %, or even from about 50 mole % to about 70 mole % propylene, and at least 2 mole %, at least about 5 mole %, at least about 10 mole %, at least about 20 mole %, at least about 30 mole %, no greater than about 50 mole %, or even from about 20 mole % to about 50 mole % of at least one alpha-olefin comonomer.

The propylene-alpha-olefin polymer optionally is a blend that includes at least one propylene-alpha-olefin polymer set forth above and at least one additional propylene-alpha-olefin polymer. Useful additional propylene-alpha-olefin polymers include the propylene-alpha-olefin polymers set forth above, propylene-alpha-olefin polymers that exhibit the viscosity, Tg, Mz, Mn, Mz/Mn, and Mz/Mw properties set forth above and a crystallinity of at least 2%, at least 5%, at least about 10%, no greater than about 30%, or even no greater than about 20%, and combinations thereof.

The propylene-alpha-olefin polymer preferably is a modified propylene-alpha-olefin polymer having the properties set forth above. A modified propylene-alpha-olefin polymer is a propylene-alpha-olefin polymer that has been treated with a free radical initiator such that the viscosity and z average molecular weight of the modified propylene-alpha-olefin polymer are less than the propylene-alpha-olefin polymer prior to modification. The propylene-alpha-olefin polymer from which the modified propylene-alpha-olefin polymer is derived is referred to herein as the unmodified propylene-alpha-olefin polymer.

The modified propylene-alpha-olefin polymer preferably exhibits a viscosity that is at least 25% less than, at least 30% less than, or even at least 35% less than the viscosity of the starting (i.e., unmodified) propylene-alpha-olefin polymer, an Mz that is at least 25% less than, at least 30% less than, or even at least 35% less than the Mz of the starting polymer and an Mz/Mn that is at least 25% less than, at least 30% less than, or even at least 35% less than the Mz/Mn of the starting polymer.

Useful unmodified propylene-alpha-olefin polymers from which the modified propylene-alpha-olefin polymer can be derived exhibit a viscosity of at least about 1,500 cps, no greater than 50,000 cps, no greater than about 10,000 cps, no greater than about 8,000 cps, no greater than about 6,000 cps, from about 1,500 cps to about 20,000, or even from about 2,500 cps to about 10,000 cps at 190° C., a Mz/Mn of at least 40, greater than 45, greater than 50, or even greater than 55, and a Mz/Mw of at least 3.2, at least 4, or even at least 5. The unmodified propylene-alpha-olefin polymer also preferably exhibits a glass transition temperature (Tg) of less than −0° C., less than −10° C., or even less than −20° C.

Useful unmodified propylene-alpha-olefin polymers exhibit a number average molecular weight (Mn) of at least about 1,000 g/mole, no greater than about 10,000 g/mole, or even no greater than about 8,000 g/mole, a weight average molecular weight (Mw) of no greater than 100,000 g/mole, at least about 20,000 g/mole, or even at least about 15,000 g/mole, and a z average molecular weight (Mz) of no greater than 300,000 g/mole, no greater than about 250,000 g/mole, no greater than about 200,000 g/mole, no greater than about 175,000 g/mole, no greater than about 145,000 g/mole, or even no greater than about 120,000 g/mole.

Useful unmodified propylene-alpha-olefin polymers also exhibit a crystallinity of at least 5%, at least about 8%, at least about 10%, at least about 12%, at least about 20%, at least about 25% or even no greater than about 30%, and a heat of fusion of no greater than about 60 J/g, no greater than about 30 J/g, or even no greater than about 20 J/g.

Useful unmodified propylene-alpha-olefin polymers from which the modified propylene-alpha-olefin polymer can be derived are commercially available under a variety of trade designations including, e.g., the REXTAC 2000 series of trade designations from Rextac LLC (Odessa, Tex.) including REXTAC RT 2765 propylene butene copolymer, REXTAC RT 2788 propylene-butene copolymer, REXTAC RT 2780 propylene-butene copolymer, REXTAC RT 2115 propylene homopolymer, REXTAC RT 2215 propylene-ethylene copolymer, REXTAC RT 2385 propylene-ethylene copolymer, REXTAC RT 2535 propylene-ethylene copolymer, and REXTAC RT 2585 propylene-ethylene copolymer, the EASTOFLEX series of trade designations from Eastman Chemical Co. (Kingsport, Tenn.) including EASTOFLEX E1060 propylene-ethylene copolymer, and the VESTOPLAST series of trade designations from Evonik Industries (Marl, Germany) including VESTOPLAST EP NC 702 propylene-butene-ethylene terpolymer, and VESTOPLAST 608 propylene-butene-ethylene terpolymer, and combinations thereof.

The adhesive composition preferably includes at least 40% by weight, at least about 50% by weight, at least about 70% by weight, no greater than about 95% by weight, no greater than about 90% by weight, from about 40% by weight to about 95% by weight, or even from about 60% by weight to about 90% by weight propylene-alpha-olefin polymer.

One useful method of making a modified propylene-alpha-olefin polymer includes treating at least one propylene-alpha-olefin polymer with a free radical initiator at an elevated temperature to provide a low viscosity, hot melt adhesive composition. The treatment alters the weight average molecular weight and the z average molecular weight of the propylene-alpha-olefin polymer and causes a decrease in the melt viscosity of the propylene-alpha-olefin polymer.

Useful free-radical initiators include, e.g., peroxide type compounds, azo-type compounds, and mixtures thereof. Examples of suitable peroxide compounds include diacyl peroxides, peroxy esters, peroxy ketals, di-alkyl peroxides, and hydroperoxides, specifically hydrogen peroxide, benzoyl peroxide, deconoyl peroxide, lauroyl peroxide, succinic acid peroxide, cumere hydroperoxide, t-butylhydroperoxide, t-butyl peroxy acetate, 2,2 di (t-butyl peroxy) butane di-allyl peroxide), 2,5-dimethyl-2,5-di(tertiarybutyl peroxy) hexane, cumyl peroxide, and combinations thereof. Suitable 2,5-dimethyl-2,5-di(tertiarybutyl peroxy) hexanes are commercially available under the LUPERSOL 101 trade designation from United Initiator Incorporated (Elyria, Ohio).

Examples of suitable azo-type compounds include azobisisobutyronitrile (AIBN), 2,2′-azobis (N,N′-dimethyleneisobutyramide) dihydrochloride (one example of which is commercially available under the VA-044 trade designation from Wako Chemical Co.), 2,2′-azobis(2,4-dimethyl valeronitrile) (one example of which is commercially available under the V-65 trade designation from Wako Chemical Co.), VAZO 64 2,2-azobis(isobutyronitrile) and VAZO 67 2,2′-azobis(2-methylbutyronitrile) both of which are commercially available from du Pont de Nemours and Company (Wilmington, Del.) and 1,1′-azobis (1-cyclohexane carbonitrile), and acid-functional azo-type initiators e.g., 4,4′-azobis (4-cyanopentanoic acid), and combinations thereof.

The free-radical initiator preferably is present in the reaction mixture in an amount from about 0.005% by weight to about 10% by weight, or even from about 0.01% by weight to about 5% by weight, based on the weight of the propylene-alpha-olefin polymer.

The reaction preferably proceeds at a temperature of from about 150° C. to about 250° C., or even from about 175° C. to about 225° C. The reaction time may vary from less than a few minutes to several hours depending on the temperature used and the half-life of the free radical initiator being used.

The reaction can be carried out in using any suitable method including, e.g., continuous processes and batch processes. Suitable continuous processes include, e.g., processes that use extruders (e.g., single screw, twin screw, disk screw, reciprocating single screw, and pin barrel single screw) and processes that use tandem extrusion techniques. Suitable batch processes include, e.g., processes that utilize reaction vessels. Suitable reaction vessels include those made from glass or metal. For example, the reactions may be conducted in glass flasks, glass lined reactors, steel autoclaves, extruders, Brabender plastographs, and Banbury mixers. The reactions may be conducted in the presence of air or under inert gases such as nitrogen. Although not required, it is also possible to carry out the treatment in the presence of an inert solvent such as benzene.

When the propylene-alpha-olefin polymer is a blend of at least two propylene-alpha-olefin polymers, the blend can be prepared using a variety of methods including, e.g., mixing the at least two polymers together prior to modifying the mixture in the reaction vessel (e.g., a batch reactor or an extruder), connecting reactors together in series to make reactor blends, blending modified polymers after reaction, blending modified and unmodified polymers, and combinations thereof.

Tackifying Agent

Useful tackifying agents have Ring and Ball softening point of less than about 140° C., less than about 130° C., or even less than about 100° C. Suitable classes of tackifying agents include, e.g., aromatic, aliphatic and cycloaliphatic hydrocarbon resins, mixed aromatic and aliphatic modified hydrocarbon resins, aromatic modified aliphatic hydrocarbon resins, and hydrogenated versions thereof; terpenes, modified terpenes and hydrogenated versions thereof; natural rosins, modified rosins, rosin esters, and hydrogenated versions thereof; low molecular weight polylactic acid; and combinations thereof. Examples of useful natural and modified rosins include gum rosin, wood rosin, tall oil rosin, distilled rosin, hydrogenated rosin, dimerized rosin, and polymerized rosin. Examples of useful rosin esters include e.g., glycerol esters of pale wood rosin, glycerol esters of hydrogenated rosin, glycerol esters of polymerized rosin, pentaerythritol esters of natural and modified rosins including pentaerythritol esters of pale wood rosin, pentaerythritol esters of hydrogenated rosin, pentaerythritol esters of tall oil rosin, and phenolic-modified pentaerythritol esters of rosin. Examples of useful polyterpene resins include polyterpene resins having a softening point, as determined by ASTM method E28-58T, of from about 10° C. to about 140° C., hydrogenated polyterpene resins, and copolymers and terpolymers of natural terpenes (e.g. styrene-terpene, alpha-methyl styrene-terpene and vinyl toluene-terpene). Examples of useful aliphatic and cycloaliphatic petroleum hydrocarbon resins include aliphatic and cycloaliphatic petroleum hydrocarbon resins having Ring and Ball softening points of from about 10° C. to about 140° C. (e.g., branched and unbranched C5 resins, C9 resins, and C10 resins) and the hydrogenated derivatives thereof.

Useful tackifying agents are commercially available under a variety of trade designations including, e.g., the ESCOREZ series of trade designations from Exxon Mobil Chemical Company (Houston, Tex.) including ESCOREZ 5400, ESCOREZ 5415, ESCOREZ 5600, ESCOREZ 5615, and ESCOREZ 5690, the EASTOTAC series of trade designations from Eastman Chemical (Kingsport, Tenn.) including EASTOTAC H-100R, EASTOTAC H-100L, and EASTOTAC H 130W, the WINGTACK series of trade designations from Cray Valley HSC (Exton, Pa.) including WINGTACK 86, WINGTACK EXTRA and WINGTACK 95 and the PICCOTAC series of trade designations from Eastman Chemical Company (Kingsport, Tenn.) including, e.g., PICCOTAC 8095.

The adhesive composition preferably includes at least about 5% by weight, at least about 10% by weight, from about 5% by weight to about 60% by weight, from about 10% by weight to about 40% by weight, or even from about 10% by weight to about 30% by weight tackifying agent.

Wax

The adhesive composition optionally includes a wax. Useful waxes are solid at room temperature and preferably have a Ring and Ball softening point of from 50° C. to 120° C. Useful classes of waxes include, e.g., functionalized waxes, non-functionalized waxes, and combinations thereof.

Useful functionalized waxes include at least one polar functional group. Examples of useful functional groups include alcohol, acid, anhydride, ketone, aldehyde, ester, amine, thiol, and combinations thereof. Useful functionalized waxes include waxes modified with alcohol, acid (e.g., maleic acid), anhydride (maleic anhydride), ketone, and combinations thereof. Useful functionalized waxes include, e.g., functionalized polypropylene waxes (e.g., maleated polypropylene and oxidized polypropylene), functionalized polyethylene waxes (e.g., maleated polyethylene wax, oxidized polyethylene wax, hydroxy-modified polyethylene wax, and combinations thereof), polar waxes, functionalized stearamide waxes (e.g., hydroxystearamide, N-(2-hydroxy ethyl)-12-hydroxoystearamide, N,N′-ethylene bis 12-hydroxystearamide, and 12-hydroxy stearic acid N,N′ ethylene-bis stearamide), and combinations thereof.

Useful non-functionalized waxes include, e.g., Fischer Tropsch waxes (e.g., oxidized Fischer-Tropsch waxes), polyolefin waxes (e.g., polypropylene waxes, polyethylene waxes, high density low molecular weight polyethylene waxes, and by-product polyethylene waxes), paraffin waxes, microcrystalline waxes, metallocene waxes, vegetable waxes, animal waxes, stearamide waxes, glycerin monostearate, sorbitan monostearate, and combinations thereof. Useful low molecular weight polyethylene waxes (i.e., polyethylene having a weight average molecular weight (Mw) of from 500 to 10,000) have an ASTM softening point of from about 65° C. to about 125° C. Useful paraffin waxes have a melting point of from about 50° C. to about 80° C. Useful microcrystalline waxes have a melting point of from about 55° C. to about 95° C. as determined by ASTM method D127-60.

Useful commercially available waxes include, e.g., EPOLENE N-21 linear polyethylene wax, which is available from Westlake Chemical Corporation, and PX105 Fischer-Tropsch wax from Baker Hughes Inc (Houston, Tex.).

When wax is present, the adhesive composition includes no greater than 10% by weight, no greater than about 7% by weight, no greater than about 5% by weight, at least 2% by weight, or even from about 2% by weight to about 10% by weight wax.

Plasticizer

The adhesive composition optionally includes a plasticizer. Useful classes of plasticizers include liquid and solid plasticizers. Useful plasticizers include, e.g., naphthenic petroleum-based oils, paraffinic oils (e.g., cycloparaffin oils), mineral oils, phthalate esters, adipate esters, olefin oligomers (e.g., oligomers of polypropylene, polybutene, and hydrogenated polyisoprene), polybutenes, polyisoprene, hydrogenated polyisoprene, polybutadiene, benzoate esters, animal oil, derivatives of oils, glycerol esters of fatty acids, and combinations thereof.

Useful commercially available plasticizers include plasticizers sold under the NYFLEX series of trade designations including NYFLEX 222B from Nynas Corporation (Houston, Tex.), KAYDOL OIL from Sonneborn (Tarrytown N.Y.) PARAPOL polybutene from Exxon Mobil Chemical Company (Houston, Tex.), OPPANOL polyisobutylene from BASF (Ludwigsjhafen, Germany), BENZOFLEX 352 benzoate ester plasticizer from Velsicol Chemical Company (Chicago, Ill.), KRYSTOL 550 mineral oil from Petrochem Carless Limited (Surrey, England), and CALSOL 550 oil from Calumet Specialty Products Partners, LP (Indianapolis, Ind.).

When plasticizer is present in the adhesive composition, the adhesive composition includes from about 1% by weight to about 20% by weight, from about 2% by weight to about 15% by weight, from about 2% by weight to about 10% by weight, no greater than about 20% by weight, no greater than 10% by weight, or even no greater than 7% by weight plasticizer.

Additional Components

The hot melt adhesive composition optionally includes additional components including, e.g., stabilizers, antioxidants, additional polymers, adhesion promoters, ultraviolet light stabilizers, rheology modifiers, biocides, corrosion inhibitors, dehydrators, colorants (e.g., pigments and dyes), fillers, surfactants, flame retardants, and combinations thereof.

Useful antioxidants include, e.g., pentaerythritol tetrakis[3,(3,5-di-tert-butyl-4-hydroxyphenyl)propionate], 2,2′-methylene bis(4-methyl-6-tert-butylphenol), phosphites including, e.g., tris-(p-nonylphenyl)-phosphite (TNPP) and bis(2,4-di-tert-butylphenyl)4,4′-diphenylene-diphosphonite, di-stearyl-3,3′-thiodipropionate (DSTDP), and combinations thereof. Useful antioxidants are commercially available under a variety of trade designations including, e.g., the IRGANOX series of trade designations including, e.g., IRGANOX 1010, IRGANOX 565, and IRGANOX 1076 hindered phenolic antioxidants and IRGAFOS 168 phosphite antioxidant, all of which are available from BASF Corporation (Florham Park, N.J.), and ETHYL 702 4,4′-methylene bis(2,6-di-tert-butylphenol). When present, the adhesive composition preferably includes from about 0.1% by weight to about 2% by weight antioxidant.

Useful additional polymers include, e.g., homopolymers, copolymers, and terpolymers, thermoplastic polymers including, e.g., polyolefins (e.g., polyethylene, polypropylene, metallocene-catalyzed polyolefins, and combinations thereof), elastomers including, e.g., elastomeric block copolymers (e.g., styrene-butadiene-styrene, styrene-isoprene-styrene, styrene-ethylene-butene-styrene, styrene-ethylene-propylene-styrene, metallocene-based elastomeric block copolymers, and combinations thereof), and combinations thereof.

Useful photoinitiators are capable of promoting free radical polymerization, crosslinking, or both, of the ethylenically unsaturated moiety on exposure to radiation of a suitable wavelength and intensity. The photoinitiator can be used alone, or in combination with a suitable donor compound or a suitable cointiator. The photoinitiator and the amount thereof are preferably selected to achieve a uniform reaction conversion, as a function of the thickness of the composition being cured, as well as a sufficiently high degree of total conversion so as to achieve the desired initial handling strength (i.e., green strength).

Useful photoinitiators include, e.g., “alpha cleavage type” photoinitiators including, e.g., benzyl dimethyl ketal, benzoin ethers, hydroxy alkyl phenyl ketones, benzoyl cyclohexanol, dialkoxy acetophenones, 1-hydroxycyclohexyl phenyl ketone, trimethylbenzoyl phosphine oxides, methyl thio phenyl morpholino ketones and morpholino phenyl amino ketones; hydrogen abstracting photoinitiators; and combinations thereof.

Useful commercially available photoinitiators are available under a variety of trade designations including, e.g., IRGACURE 369 morpholino phenyl amino ketone, IRGACURE 819 bis(2,4,6-trimethylbenzoyl)-phenylphosphine oxide, IRGACURE CGI 403 bis(2,6-dimethoxybenzoyl)-(2,4,4-trimethylpentyl)phosphine oxide, IRGACURE 651 benzyl dimethyl ketal, and IRGACURE 184 benzoyl cyclohexanol all of which are available from BASF Corporation (Florham Park, N.J.), DAROCUR 1173 hydroxy alkyl phenyl ketones, DAROCUR 4265 50:50 blend of 2-hydroxy-2-methyl-1-phenylpropan-1-one and 2,4,6-trimethylbenzoyldiphenylphosphine oxide, and CGI1700 25:75 blend of bis(2,6-dimethoxybenzoyl)-2,4,4-trimethylpentylphosphine and 2-hydroxy-2-methyl-1-phenylpropan-1-one, which are available from Ciba-Geigy Corp. (Ardsley, N.Y.)

The photoinitiator is preferably present in an amount sufficient to provide the desired rate of photopolymerization. The amount will depend, in part, on the light source, the thickness of the layer to be exposed to radiant energy and the extinction coefficient of the photoinitiator at the wavelength. The adhesive composition optionally includes from about 0.01% by weight to about 5% by weight, more preferably from about 0.1% by weight to about 1% by weight photoinitiator.

Uses

The adhesive composition is useful in a variety of forms including, e.g., coating (e.g., continuous coatings and discontinuous (e.g., random, pattern, and array) coatings), film (e.g., continuous films and discontinuous films), and fibers. The adhesive composition can be applied to or incorporated in a variety of substrates including, e.g., films (e.g., polyolefin (e.g., polyethylene and polypropylene) films), release liners, porous substrates, cellulose substrates, sheets (e.g., paper, and fiber sheets), paper products, woven and nonwoven webs, fibers (e.g., synthetic polymer fibers and cellulose fibers), and tape backings.

The adhesive composition is also useful in a variety of applications and constructions including, e.g., disposable absorbent articles including, e.g., disposable diapers, sanitary napkins, medical dressings (e.g., wound care products) bandages, surgical pads, drapes, gowns, and meat-packing products, paper products including, e.g., paper towels (e.g., multiple use towels), toilet paper, facial tissue, wipes, tissues, towels (e.g., paper towels), sheets, mattress covers, and components of absorbent articles including, e.g., an absorbent element, absorbent cores, impermeable layers (e.g., backsheets), tissue (e.g., wrapping tissue), acquisition layers and woven and nonwoven web layers (e.g., top sheets, absorbent tissue), labels, tapes, packaging (e.g., boxes, cartons, trays, and bags (e.g., paper and polymeric)), filters (e.g., pleated filters and filter frames), and combinations thereof.

The adhesive composition is useful on substrates made from a variety of fibers including, e.g., natural cellulose fibers such as wood pulp, cotton, silk and wool; synthetic fibers such as nylon, rayon, polyesters, acrylics, polypropylenes, polyethylene, polyvinyl chloride, polyurethane, and glass; recycled fibers, and various combinations thereof.

Various application techniques can be used to apply the adhesive composition to a substrate including, e.g., slot coating, spraying including, e.g., spiral spraying and random spraying, screen printing, foaming, engraved roller, extrusion and meltblown adhesive application techniques.

The invention will now be described by way of the following examples. All parts, ratios, percents and amounts stated in the Examples are by weight unless otherwise specified.

### EXAMPLES

### Test Procedures

Test procedures used in the examples include the following.

### Method of Determining Molecular Weight

Molecular weights (Mn, Mw, and Mz) are determined using a Polymer Labs PL-GPC 220 High Temperature Size Exclusion Chromatograph (HT-SEC) operating at 160° C. with 1,2,4-trichlorobenzene (TCB) as the mobile phase. The system contains three PL-gel mixed B columns in series and is equipped with a Refractive Index (RI) detector. The SEC operates at a flow rate of 1.01 ml/min with an injection volume of 100 μL. All HT-SEC samples are prepared with a concentration of 4.01 mg/ml. Molecular weights are calculated from the Mark-Houwink relation using known polystyrene standards. For polystyrene the Mark-Houwink parameters are K=0.000121 and α=0.707; for polypropylene the Mark-Houwink parameters are polypropylene, K=0.000190 and α=0.725. The results are reported in grams per mole (g/mole).

### Viscosity Test Method

Viscosity is determined in accordance with ASTM D-3236 entitled, “Standard Test Method for Apparent viscosity of Hot Melt Adhesives and Coating Materials,” (Oct. 31, 1988), using a Brookfield Thermosel viscometer Model RVDV 2 and a number 27 spindle. The results are reported in centipoise (cps).

### Test Sample Preparation

A multi-bead applicator and laminator are set to a temperature (e.g., 149° C.) that is appropriate for application of the sample hot melt composition, a nip pressure of 15 psi, an application weight of 1.4 mg/in (milligrams per inch), and minimal rewind and unwind tensions that will not stretch the film used in the samples. A 1 mil thick white embossed polyethylene film is passed through the applicator. The film is a blend of linear low density polyethylene and low density polyethylene (e.g., DH-284 PE MICROFLEX Embossed Non-Breathable film having an emboss gauge of 1.8 mils (as determined according to ASTM D374), 70 gram F50 impact strength (as determined according to ASTM D1709), 670% elongation at break in the machine direction (as determined according to ASTM D882), 920% elongation at break in the cross direction (as determined according to ASTM D882), 590 grams tensile at 10% elongation in the machine direction (as determined according to ASTM D882), 550 grams tensile at 10% elongation in the cross direction (as determined according to ASTM D882), 2,500 ultimate tensile in the machine direction (as determined according to ASTM D882), and 1,700 grams ultimate tensile in the cross direction (as determined according to ASTM D882), which is available from Clopay Plastic Products Company, Inc., (Cincinnati, Ohio) or equivalent thereof), which has been corona treated on one side thereof to a surface energy of 38 dynes per square centimeter (dynes/cm²) (as measured using dynes pens). A bead of the sample hot melt composition is applied by the applicator to the corona treated side of the polymer film and then the film and the sample hot melt composition are nipped to a 15 grams/square meter (g/m²) basis weight spunbond polypropylene nonwoven web having a 7 mil Thwing-Albert thickness (e.g., UNIPRO 45 nonwoven web from Midwest Filtration Company) to form a laminate.

The speed at which the film passes through the applicator is from 400 feet per minute (ft/min) to 900 ft/min and the adhesive coat weight is 1.4 mg/in. A sufficient amount of laminate is prepared such that 60 inches of representative lamination can be collected for testing.

### Bleed Through Test Method

From seven to ten test samples are cut from the laminate prepared according to the Test Sample Preparation method immediately after the laminate is prepared. The test samples are cut to a length of seven inches in the machine direction and one inch in the cross-machine direction while ensuring that the bead of hot melt sample composition is centered in the cross-machine direction of the test sample. These samples form the test strips.

Additionally, from seven to ten blank strips are cut from the same roll of corona-treated polymer film that is used to prepare the test strips. The blank strips of polymer film are cut to a length of seven inches in the machine direction and one inch in the cross-machine direction being careful to note which side is the corona treated side of the polymer film.

A 3,500 g weight and two glass plates (5 inch long by 4 inch wide) are preconditioned in an oven at 120° F. and 50% relative humidity for at least one hour before starting the test. A 1 in. by 7 in. blank strip of the corona treated polymer film is placed on one of the glass plates with the corona-treated side of the film facing up (i.e., the treated side is not in contact with the glass plate). A 1 in. by 7 in. test strip is then placed on the blank strip of polymer film such that the polymer film side of the test strip is facing up and the nonwoven side of the test strip is facing down (i.e., in contact with the blank strip of corona-treated polymer film). A second blank strip of polymer film is then placed on top of the first test strip such that the untreated side of the second blank strip of polymer film contacts the treated side of the polymer film of the first test strip. Then, a second test strip is placed on top of the second blank strip of polymer film with the polymer film side of the test strip facing up. This procedure is repeated until all the test strips have been added to the stack.

A second glass plate is then placed on top of the stack of alternating polymer film layers and test strips. The heated 3,500 g weight is placed on the second glass plate such that the samples are pressed between the two glass plates. The stack is then placed in the 120° F. oven at 50% relative humidity for one hour. The stack is then removed after one hour and allowed to cool at room temp (about 21° C.) and 50% relative humidity for 15 minutes.

Each test sample, which includes the test strip and neighboring corona-treated polymer film, is then removed from the stack and tested according to a T-peel test method. The test strip of the test sample is placed in stationary grip of the tester and the blank corona-treated polymer film is placed in the moving grip of the tester. The corona-treated polymer film is peeled back from the test strip at a rate of 12 inches per minute (in/min) over a ten second peel time. The peak peel value is obtained for each test sample and recorded.

This test is repeated for each of the test samples (i.e., each pair of blank polymer film and test strip). The average of the peak values and the standard deviation of the peak peel values for the seven to ten test samples are obtained and reported in grams (g).

### Peel Force Test Method

Peel force is determined using ASTM D1876-01 entitled. “Test Method for Determining, Peel Resistance of Adhesive (T-Peel Test Method).” with the exception that the test is run at a rate of 12 inches per minute, instead of ten in per minute, over a period of ten seconds, and seven replicates are run instead of the ten specified in ASTM D1876. The samples are run on an INSTRON type-test instrument. The test samples are prepared as described in the Test Sample Preparation with the exception that the sample hot melt composition is coated in a spiral spray pattern with a coat weight of 6.2 g/m². The average peel force over ten seconds of peeling is recorded, and the results are reported in grams. The initial peel force is measured 24 hours after the laminate is prepared. The two week peel force is measured after the sample has been subjected to accelerated aging at 50° C. and 50% relative humidity for two weeks. The four week peel force is measured after the sample has been subjected to accelerated aging at 50° C. and 50% relative humidity for four weeks.

### Low Coat Weight Peel Force Test Method

The low coat weight peel force is determined according to the Peel Force Test Method with the exception that the coat weight is 4.0 g/m² instead of 6.2 g/m². The initial peel force is measured 24 hours after the laminate is prepared. The two week peel force is measured after the sample has been subjected to accelerated aging at 50° C. and 50% relative humidity for two weeks. The four week peel force is measured after the sample has been subjected to accelerated aging at 50° C. and 50% relative humidity for four weeks.

### Sprayability Test Method

A sample hot melt composition is heated to 149° C. and sprayed onto a treated polyethylene film in a randomized pattern using three 25 mm Uniform Signature nozzles (Nordson Corporation, Westlake, Ohio). The adhesive applicator and process air are also heated to the appropriate application temperature and the process air pressure is held constant at 20 psi. The composition is deemed sprayable if it is capable of producing a continuous pattern at a web speed of 500 feet per minute (ft/min) and a coat weight of 3.0 grams per meter squared (g/m²) without exhibiting excessive stringing or back spraying.

### Modified Propylene-Butene Copolymer 1

A propylene-butene copolymer (having 65% by weight propylene and 35% by weight butene), having a manufacturer's target viscosity of 6,500 cps at 190° C., was treated with 1.25% by weight LUPRESOL 101 organic peroxide (United Initiator Incorporated, Elyria, Ohio) at a temperature of about 400° F. (204.4° C.) in an extruder for a residence time of 90 seconds. The resulting modified propylene-butene copolymer had a viscosity of 1,570 cps at 177° C., a Mz of 83,900, a Mn of 3590, and a Mw of 28,600.

### Control 1

Control 1 was prepared by combining, at 177° C. and with mixing, a propylene-butene copolymer (having 65% by weight propylene and 35% by weight butene and a manufacturer's target viscosity of 6,500 cps at 190° C.), 0.5% by weight IRGANOX 1010 antioxidant, PICCOTAC 8095 C5 hydrocarbon tackifying agent (Eastman Chemical Company), and EPOLENE N21 polyethylene wax (Westlake Chemical Corporation) in the amounts (IN % by weight) specified in Table 1. Control 1 required an application temperature of 163° C. and could not be sprayed using a Signature nozzle.

### Examples 1-3

Examples 1-3 were prepared by combining, at 177° C. and with mixing, the modified propylene-butene copolymer 1 that was prepared above, antioxidant (0.2 weight % IRGANOX 1076 and 1.0 weight % IRGAFOS 168 for Example 1 and 0.5 weight % IRGANOX 1010, 1.0 weight % IRGAFOS 168 for Examples 2 and 3), PICCOTAC 8095 C5 hydrocarbon tackifying agent, and, where indicated, EPOLENE N21 polyethylene wax in the amounts (% by weight) specified in Table 1.

The viscosity of the compositions of Control 1 and Examples 1 and 2 was determined at 177° C., 149° C., and 135° C. according to the Viscosity test method and the results are reported in Table 1 in centipoise. The compositions of Control 1 and Examples 1 and 2 were also tested according to the Bleed Through test method and the results are reported in Table 1.

TABLE 1

| | | | | | | | Bleed |
|---|---|---|---|---|---|---|---|
| | | | | Viscosity | Viscosity | Viscosity | Through |
| Sample | Polymer | Tackifier | Wax | @ 177° C. | @ 149° C. | @ 135° C. | (g) |
| Control 1 | 78.5 | 19 | 2 | 4575 | 11,000 | 30,000 | 11 |
| Example 1 | 77.8 | 19 | 2 | 2100 | 5100 | 8575 | NM |
| Example 2 | 77.5 | 19 | 2 | 2050 | 3350 | 6050 | 0 |
| Example 3 | 79.5 | 19 | 0 | 2200 | 3350 | 6200 | 0 |

Examples 1-3, when tested according to the Sprayability Test Method, are expected to be deemed sprayable. Control 1, when tested according to the Sprayability Test Method, is expected to be deemed not sprayable.

Samples of the compositions of Control 1 and Examples 1 and 2 were coated at the coat weights specified in Table 2 in grams per meter squared (g/m²) and tested according to the Peel Force Test Method at initial, two weeks, and four weeks. The results are set forth in Table 2.

TABLE 2

| | | Initial Peel | 2 Week Peel | 4 Week Peel |
|---|---|---|---|---|
| Sample | Coat Weight | Force (g) | Force (g) | Force (g) |
| Example 1 | 6.2 g/m² | 326 | 339 | 391 |
| Control 1 | 6.2 g/m² | 216 | 100 | 83 |
| Example 2 | 6.2 g/m² | 302 | 284 | 320 |
| Example 3 | 6.2 g/m² | 362 | 469 | 567 |
| Example 1 | 4.7 g/m² | 207 | 237 | 260 |
| Control 1 | 4.0 g/m² | 42 | 38 | 33 |
| Example 2 | 4.0 g/m² | 89 | 107 | 128 |
| Example 3 | 4.0 g/m² | 211 | 231 | 254 |

All patents and references referred to herein are incorporated herein.

Other embodiments are within the claims.

What is claimed is:

1. A hot melt adhesive composition comprising:
a propylene-alpha-olefin polymer comprising at least 50 mole % propylene and having a ratio of z average molecular weight (Mz) to number average molecular weight (Mn) (Mz/Mn) from greater than 20 to no greater than 50, a ratio of Mz to weight average molecular weight (Mw) (Mz/Mw) from greater than 2.5 to no greater than 6, a crystallinity of at least 5%, and a viscosity of no greater than 2500 centipoise at 190° C.; and
from 10% by weight to no greater than 30% by weight tackifying resin,
the adhesive composition having a viscosity no greater than 10,000 centipoise at 149° C.

2. The hot melt adhesive composition of claim 1, wherein the hot melt adhesive composition is pressure-sensitive.

3. A pressure-sensitive hot melt adhesive composition comprising:
a first polymer comprising the reaction product of
a propylene-alpha-olefin polymer comprising at least 50 mole % propylene and having a Mz/Mn of greater than 45, a Mz/Mw of greater than 3.2, a viscosity no greater than 10,000 centipoise at 190° C., and a crystallinity of at least 5%, and
a free radical initiator; and
from 10% by weight to no greater than 30% by weight tackifying resin,
the adhesive composition having a viscosity no greater than 10,000 centipoise at 149° C.

4. The hot melt adhesive composition of claim 1 having a viscosity no greater than about 8000 centipoise at 149° C.

5. The hot melt adhesive composition of claim 1 exhibiting an initial peel force of at least 100 grams.

6. The hot melt adhesive composition of claim 1 exhibiting an initial peel force of at least about 200 grams.

7. The hot melt adhesive composition of claim 1 exhibiting an initial low coat weight peel force of at least about 150 grams.

8. The hot melt adhesive composition of claim 1 exhibiting a bleed through of less than about 30 grams.

9. The hot melt adhesive composition of claim 5, exhibiting a bleed through of less than about 30 grams.

10. The hot melt adhesive composition of claim 9, exhibiting an initial low coat weight peel force of at least 100 grams.

11. The hot inch adhesive composition of claim 9, exhibiting an initial low coat weight peel force of at least about 150 grams.

12. The hot melt adhesive composition of claim 9, exhibiting an initial peel force of at least about 175 grams.

13. The hot melt adhesive composition of claim 1, exhibiting no bleed through.

14. The pressure-sensitive hot melt adhesive composition of claim 10, exhibiting no bleed through.

15. The hot melt adhesive composition of claim 1, wherein the propylene-alpha-olefin polymer exhibits at least 10% crystallinity.

16. The hot melt adhesive composition of claim 1, wherein the propylene-alpha-olefin polymer exhibits a heat of fusion of no greater than about 30 J/g.

17. The hot melt adhesive composition of claim 1, comprising no greater than about 25% by weight tackifying agent.

18. The hot melt adhesive composition of claim 1, comprising at least about 50% by weight propylene-alpha-olefin polymer.

19. The hot melt adhesive composition of claim 1, comprising at least about 70% by weight propylene-alpha-olefin polymer.

20. The hot melt adhesive composition of claim 1 further comprising from about 0.5% by weight to about 3% by weight wax.

21. The hot melt adhesive composition of claim 1 further comprising at least one of plasticizer and wax.

22. The hot melt adhesive composition of claim 1 further comprising a plasticizer comprising oil.

23. A hot melt adhesive composition comprising
a propylene-alpha-olefin polymer comprising at least 50 mole % propylene; and
from 10% by weight to no greater than about 30% by weight tackifying resin,
the adhesive composition
having a viscosity no greater than 10,000 centipoise at 149° C.,
exhibiting an initial low coat weight peel force of at least 175 g, and
exhibiting a bleed through of no greater than 30 g.

24. The hot melt adhesive composition of claim 23, wherein the composition is a pressure sensitive hot melt adhesive composition.

25. An article comprising:
a first substrate;
the hot melt adhesive composition of claim 1; and
a nonwoven web adhered to the first substrate through the hot melt adhesive composition.

26. The article of claim 25, wherein the hot melt adhesive composition exhibits a bleed through of no greater than about 30 grams.

27. The article of claim 25, wherein
the nonwoven web comprises a first major surface and a second major surface opposite the first major surface,
the hot melt adhesive is disposed on the first major surface of the nonwoven web, and
the second major surface of the nonwoven web is non-tacky.

28. The article of claim 25, wherein the article is nonblocking.
